(19) United States
(12) Patent Application Publication
(10) Pub. No.: US 2011/0234667 A1
(43) Pub. Date: Sep. 29, 2011

(54) INK JET IMAGE FORMING METHOD AND INK JET RECORDING APPARATUS

(75) Inventors: Taketoshi Okubo, Asaka-shi (JP); Atsuhito Yoshizawa, Kawasaki-shi (JP); Akira Kuriyama, Atsugi-shi (JP); Shoji Koike, Yokohama-shi (JP)

(73) Assignee: CANON KABUSHIKI KAISHA, Tokyo (JP)

(21) Appl. No.: 13/132,438

(22) PCT Filed: Jan. 14, 2010
(86) PCT No.: PCT/JP2010/050656

§ 371 Date: Jun. 2, 2011

(30) Foreign Application Priority Data
Jan. 22, 2009 (JP) 2009-012084

(51) Int. Cl. B41J 29/38

(52) U.S. Cl. 347/9

(57) ABSTRACT

An ink jet image forming method, wherein an ink is applied to plain paper in a fixed amount of 0.5 to 6.0 pl, contains a self-dispersion pigment, an organic carboxylic acid salt, water and a water-soluble compound having a hydrophilicity-hydrophobicity coefficient of 0.26 or more, and has a surface tension of 34 mN/m or less, and when the total amount of inks applied to a fundamental matrix for forming an image is 5.0 pl/cm² or less, and the duty of an ink of a color applied to the fundamental matrix is 80% duty or more, the application of the ink of a color to the fundamental matrix is conducted within a range of 1 to 200 msec and at plural timings within the above range, and the amount of the ink of a color applied at each timing is controlled to 0.7 pl/cm² or less.

### TECHNICAL FIELD

The present invention relates to an ink jet image forming method and an ink jet recording apparatus.

### BACKGROUND ART

An ink-jet recording system is widely used as an excellent recording method capable of performing recording on various recording media. In addition, ink jet recording apparatus have been rapidly spread as printing units for various kinds of uses because of their advantages such as high-speed recording, low noise, easiness of color recording and low running cost.

In recent years, ink jet printers have been widely used in offices in combination with recording apparatus of an electrophotographic system, such as laser printers and copying machines. An ink jet recording apparatus using a line head is widely utilized as an industrial printing machine because of its high-speed printing ability. When ink jet recording is conducted for these objects, cheap plain paper is often used as a recording medium.

Ink jet recording apparatus heretofore developed have involved problems in points of lowering of image density and deterioration of letter quality unless a recording medium developed for ink jet, such as coat paper, is used. In particular, the image density and letter quality have been often markedly lowered upon high-speed printing. Thus, there is a demand for shortening of recording time, improvement in image density and improvement in the quality of recorded images such as letters and photographs when recording is conducted on plain paper according to the ink jet recording system.

For example, it is required to record official documents, photographic images of digital cameras, and various kinds of information published in homepages on both sides of a plain paper sheet at high speed. It is also required to achieve such clear image quality as in a recorded image obtained through recording with a laser beam printer. It is further required to achieve a high image density when letter images are printed and to provide sharp letter images without loosing letter shapes even when small letter images are printed.

In order to meet such requirements, Japanese Patent Application Laid-Open No. 2004-195706 discloses a recording method in which an ink containing organic ultrafine particles having an average particle size of 0.5 μm or less and internally and three-dimensionally crosslinked is applied as ink droplets. This method is characterized in that recording is conducted under the conditions where the application amount of ink droplets per unit area of a recording medium is within a range of from 5 to 40 g/m². Japanese Patent Application Laid-Open No. H11-129460 discloses such an ink jet recording method that a semi-permeable ink is used and a unit for heating a recorded region on a recording medium is provided, thereby inhibiting permeation of the ink and achieving a high image density. Japanese Patent Application Laid-Open No. 2004-209762 discloses an ink jet recording method in which the applied ink quantity is controlled to a range of from 3×10⁻⁶ to 3×10⁻⁵ ml/mm² for inhibiting curling after recording. Japanese Patent Application Laid-Open No. 2002-113938 discloses an ink jet recording method in which a low-permeable ink is used and the amount of the ink used in printing per unit area is controlled to a range of from 5 to 8 μl/inch² upon printing on a recording medium. In this recording method, printing resolution is controlled to 800 to 2,400 dpi, thereby providing a high-quality image at high printing speed.

The present invention relates to an ink jet image forming method and an ink jet recording apparatus, which are suitable for use in forming a recorded image on plain paper at high speed. Objects to be achieved are shown below.
1) An ink is fixed on plain paper in a short time.
2) A recorded image has a high density and is clear.
3) Even when small letters are printed, the letters are sharp without loosing their shapes.
4) A recorded image has good water resistance and fixability.

In general, an ink containing a liquid as a main component has lost sharpness of letters or caused lowering of image density to impair image quality on a recording medium high in permeability, such as plain paper. In order to improve printing quality, it has also been attempted to use a low-permeable ink to inhibit bleeding on paper. However, the drying time of the ink is very slow, so that bleeding between colors or print-through easily occur, and so such an attempt is often unsuitable for double-side printing.

According to Japanese Patent Application Laid-Open No. 2004-195706, high-color-developing printing becomes feasible to some extent. However, image density upon high-speed printing is insufficient, and a problem is also left on letter quality when small letters are printed. According to Japanese Patent Application Laid-Open No. H11-129460, recording can be conducted with high-speed fixing and high color developing. However, a heating device is required, so that energy consumption may become great in some cases. According to Japanese Patent Application Laid-Open No. 2004-209762, curling can be inhibited by controlling the amount of an ink applied to a recording medium. However, the color developability of the resulting recorded article and letter quality upon printing of small letters may become insufficient in some cases. According to Japanese Patent Application Laid-Open No. 2002-113938, high color developability and high-speed dryability become feasible to some extent. However, this method may not meet high-speed printing in some cases because the low-permeable ink is used.

As described above, the conventional ink jet image forming methods are difficult to achieve both high-speed printing and high-quality image recording, and an ink jet image forming method capable of sufficiently satisfying all the above 4 objects at the same time is not found.

It is an object of the present invention to provide an ink jet image forming method and an ink jet recording apparatus, which sufficiently satisfy the above subjects 1) to 4) at the same time.

### DISCLOSURE OF THE INVENTION

The above object can be achieved by the present invention described below. More specifically, the present invention provides an ink jet image forming method for forming an image by applying an ink of a color to plain paper with an ink jet recording system, wherein the ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the following equation (A), and has a surface tension of 34 mN/m or less, and wherein when the total amount of the ink applied to a fundamental matrix for forming the image is 5.0 μl/cm² or less, and the duty of the ink applied to the fundamental matrix is 80% duty or more, the application of the ink to the fundamental matrix is conducted within a range of 1 msec or more and 200 msec or less and at plural timings within the above range, and the amount of the ink applied at each timing is controlled to 0.7 μl/cm² or less,

Hydrophilicity-hydrophobicity coefficient=[(Water activity of a 20% aqueous solution)−(Molar fraction of water in the 20% aqueous solution)]/[1−(Molar fraction of water in the 20% aqueous solution)]. Equation (A):

The present invention also provides an ink jet image forming method for forming an image by applying inks of plural colors to plain paper with an ink jet recording system, wherein when the total amount of the inks applied to a fundamental matrix for forming the image is 5.0 μl/cm² or less, and the duty of at least one ink of a color of the inks applied to the fundamental matrix is 80% duty or more, the application of the at least one ink to the fundamental matrix is conducted within a range of 1 msec or more and 200 msec or less and at plural timings within the above range, and the amount of the at least one ink applied at each timing is controlled to 0.7 μl/cm² or less, and wherein the at least one ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less.

The present invention further provides an ink jet recording apparatus equipped with a recording head for forming an image by applying an ink of a color to plain paper with an ink jet recording system, wherein the ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less, and wherein the apparatus comprises a control mechanism for controlling the application of the ink such that when the total amount of the ink applied to a fundamental matrix for forming the image is 5.0 pl/cm² or less, and the duty of the ink applied to the fundamental matrix is 80% duty or more, the application of the ink to the fundamental matrix is conducted within a range of 1 msec or more and 200 msec or less and at plural timings within the above range, and the amount of the ink applied at each timing is controlled to 0.7 μl/cm² or less.

The present invention still further provides an ink jet recording apparatus equipped with a recording head for forming an image by applying inks of plural colors to plain paper with an ink jet recording system, wherein the apparatus comprises a control mechanism for controlling the application of the inks such that when the total amount of the inks applied to a fundamental matrix for forming the image is 5.0 μl/cm² or less, and the duty of at least one ink of a color of the inks applied to the fundamental matrix is 80% duty or more, the application of the at least one ink to the fundamental matrix is conducted within a range of 1 msec or more and 200 msec or less and at plural timings within the above range, and the amount of the at least one ink applied at each timing is controlled to 0.7 μl/cm² or less, and wherein the at least one ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less.

According to the present invention, fixing of an ink can be conducted at high speed when the ink is applied to plain paper. An image having sufficient water resistance and image density can also be provided, and even when small letters are printed, the resulting letters are sharp without losing their shapes. These advantages are marked effects that are obtained by satisfying all the above-described constitutional requirements of the present invention and cannot be expected from the prior art.

Further features of the present invention will become apparent from the following description of exemplary embodiments with reference to the attached drawings.

### BRIEF DESCRIPTION OF THE DRAWINGS

FIG. 1 is a front elevation schematically illustrating a serial type ink jet recording apparatus according to an embodiment, which can be applied to the present invention.

FIG. 2 is a front elevation schematically illustrating a line type ink jet recording apparatus according to an embodiment, which can be applied to the present invention.

FIG. 3 illustrates the construction of a recording head applicable to an embodiment of the present invention.

FIG. 4 illustrates an exemplary method for forming recording dots.

### BEST MODE FOR CARRYING OUT THE INVENTION

The present invention will hereinafter be described in more detail by favorable embodiments.

The present inventors have carried out an investigation on an ink jet image forming method and an ink jet recording apparatus that provide clear and high-quality images fixed in a short time to plain paper and having sufficient water resistance and image density, and are suitable for high-speed printing and double-side printing. As a result, it has been found that the composition of an ink that quickly causes solid-liquid separation between a pigment and an aqueous medium after impact on the plain paper, physical properties of the ink, the amount of the ink applied which is controlled on the recording apparatus side, and conditions for division of the application of the ink are precisely controlled, whereby the above object can be achieved by a synergistic effect thereof.

In the present invention, the droplet volume of the ink ejected from one nozzle is controlled to a fixed amount of 0.5 pl or more and 6.0 pl or less. The amount is favorably 1.0 pl or more, more favorably 1.5 pl or more. The amount is also favorably 5.0 pl or less, more favorably 4.5 pl or less. Any amount less than 0.5 pl is not favorable because an image poor in fixability and water resistance may be provided in some cases. If the amount exceeds 6.0 pl, letters printed may loose their shapes by dot gain in some cases when small letters of the order of from 2 point (1 point≈0.35 mm) to 5 point are printed.

Since the droplet volume of the ink ejected greatly affects the strike-through of the ink, the volume is important even from the viewpoint of application to double-side printing. Pores of the size of from 0.1 μm to 100 μm with the size of 0.5 μm to 5.0 μm as the center are generally distributed in plain paper. Incidentally, the plain paper in the present invention means paper for copying used in a large amount in printers and copying machines, such as commercially available wood free paper, wood-containing paper and PPC paper, or bond paper. The permeation phenomenon of an aqueous ink into the plain paper is generally classified into the fiber absorption that the ink is directly absorbed and permeated into the cellulose fiber itself of the plain paper and the pore absorption that the ink is absorbed and permeated into pores formed between cellulose fibers. The ink used in the present invention is an ink that mainly permeates by the pore absorption though the ink will be described subsequently. Therefore, when the ink used in the present invention is applied to the plain paper and a part of the ink comes into contact with largish pores of about 10 μm or more, which are present in the surface of the plain paper, the ink is concentrated in the largish pores according to the Lucas-Washburn equation and absorbed to permeate the paper. As a result, at this portion, the ink particularly deeply permeate the paper, which is extremely disadvantageous to development of high color developing on the plain paper. On the other hand, as a droplet volume of the ink becomes smaller, the contact probability of one ink droplet with the largish pore becomes lower, so that the ink is not easily concentrated and absorbed in the largish pore. Further, even if the ink droplet comes into contact with the largish pore, the amount of the ink to deeply permeate may be small so far as the ink is small. As a result, an image having high color developing is provided on the plain paper.

The fixed amount of the ink in the present invention means the same volume of ink ejected in a state that the structures of nozzles making up a recording head are not varied among the nozzles and the setting of changing drive energy to be applied is not made. Namely, in such a state, the volume of the ink droplet applied is fixed even if ejection is somewhat varied by an error in production of apparatus. The volume of the ink droplet applied is made fixed, whereby the permeation depth of the ink is stabilized, the image density of a recorded image becomes high, and image uniformity is improved. On the contrary, according to a system in which the volume of an ink droplet applied is changed and variation in permeation depth of the ink becomes great, because the amount of the ink is not fixed and ink droplets different in volume mixedly exist. In a high duty portion of a recorded image in particular, the image uniformity is deteriorated because a portion low in image density exists in the recorded image due to the great variation in permeation depth to plain paper.

As a system suitable for applying an ink in a fixed amount, a thermal ink jet system in which the ink is applied by the action of thermal energy is favorable from the viewpoint of ejection mechanism. More specifically, according to the thermal ink jet system, the variation in permeation depth of the ink is suppressed, and the resulting recorded image is high in image density and good in uniformity. In addition, the thermal ink jet system is suitable for forming a recording head of a multi-nozzle and high-density type compared with a system in which an ink is applied by using piezoelectric elements and is also favorable for high-speed recording.

The object of the present invention is required when an image in which the duty of at least one ink of a color is 80% duty or more is formed in a fundamental matrix for forming the image. The minimum portion for calculating the duty is 50 μm×50 μm. The image with a duty of 80% or more is an image formed by applying the ink to 80% or more the lattices in the matrix of the portion for calculating the duty. The size of lattices is determined by the resolution of the fundamental matrix. For example, when the resolution of the fundamental matrix is 1,200 dpi×1,200 dpi, the size of a lattice is 1/1,200 inch× 1/1,200 inch.

The image with a duty of an ink of a color of 80% duty or more in the fundamental matrix will be described.

Incidentally, “a color” in the present invention is favorably exactly of the same color or color tone. However, if there is some difference in density, such case is also defined as “a color”. In other words, when 4 color inks of black, cyan, magenta and yellow are used, the image means an image having a portion where the duty becomes 80% or more with at least one of these inks in the fundamental matrix. On the other hand, an image having no portion where the duty of an ink of a color is 80% or more in the fundamental matrix has relatively little overlapping between inks which have impacted and may not cause a problem of loss of letter shapes in many cases even when a printing process is not modified. The present invention develops a marked effect on the problem caused by applying an ink of a color in plenty to a fundamental matrix. Therefore, the fundamental matrix, from which the duty is calculated out, is defined as a fundamental matrix of each color, i.e., ink of a color.

The fundamental matrix of the present invention can be freely set according to a recording apparatus. The resolution of the fundamental matrix is favorably 600 dpi or more, more favorably 1,200 dpi or more. The resolution is also favorably 4,800 dpi or less, since the resolution exceeding 4,800 dpi may cause deterioration of the image and letter qualities due to the increased amount of applied ink. The resolutions in the vertical and horizontal directions of the fundamental matrix may be the same or different so far as they fall within this range.

The present invention is also required in the case of forming an image in which the total amount of ink(s) applied to the fundamental matrix is 5.0 μl/cm² or less. In other words, when 4 color inks of black, cyan, magenta and yellow are used, the total amount is the amount of all these inks applied. When a single ink, for example, a black color ink is used, the total amount is the amount of the black ink applied. The portion for calculating the total amount of the ink(s) applied is the same as the portion for calculating the duty. If an image having a portion in which the total amount of all the color inks applied exceeds 5.0 μl/cm² is formed, in some cases, a clear image may not be obtained, or strike-through may occur, which is unsuitable for double-side printing.

In the present invention, the application of the ink of one color to the fundamental matrix is conducted at plural timings when such an image as described above is formed. In the present invention, when several drops of the ink are applied at the same time from one nozzle row to the fundamental matrix, such application is defined as one timing. The one nozzle row means a group of nozzles that ejects the same kind of ink.

The amount of the ink of a color applied at each timing is controlled to 0.7 μl/cm² or less, favorably 0.6 μl/cm² or less, more favorably 0.5 μl/cm² or less. If the amount of the ink of a color applied at each timing exceeds 0.7 μl/cm², strike-through, loss of letter shapes and/or bleeding may occur in some cases.

The application of the ink of a color at plural timings upon the formation of such an image is an essential requirement in the present invention. This is based on the fact that there is a particular difference in performance between the case of applying the ink at plural timings and the case of applying the ink at a time.

In the present invention, the time of application of the ink of one color to the fundamental matrix is within the range of 1 msec or more and 200 msec or less. In other words, the ink is applied at plural timings within this range to complete an image. Printing is conducted under such conditions, whereby improvement in color developability and quality of small letters is markedly observed. The control to 1 msec or more is favorable because there is a certain period of time between the first application of the ink and the last application of the ink. The reason for it is considered to be as follows. When the last ink droplet impacts before the first ink droplet is sufficiently fixed to plain paper, the respective ink droplets bond to each other to form a large droplet (beading). The large ink droplet permeates deeply from a largish pore on plain paper, so that color developability is lowered. The large ink droplet also spreads laterally along the direction of fibers in the plain paper, so that sharpness of letters is lost. In the present invention, the application of the ink of a color to the fundamental matrix is conducted within the range of 1 msec or more and 200 msec and at plural timings within the above-described range. It can thereby take a sufficient time to undergo solid-liquid separation after an ink droplet impacts on a recording medium to improve an image density and letter quality.

When application of the ink of a color to the fundamental matrix is conducted at 3 or more timings, the time interval between the respective timings is favorably controlled to 1 msec or more. Recording is conducted under such conditions, thereby alleviating lowering of the image density and deterioration of letter quality, which are caused by bonding of the respective ink droplets to each other.

Even if application of the ink of a color to the fundamental matrix is conducted at a time longer than 200 msec, the effect is not so changed compared with the effect when setting the time to 200 msec. Therefore, the upper limit is defined as 200 msec in the present invention to achieve high-speed printing. The application of the ink of a color to the fundamental matrix is conducted at 1 msec or more, favorably 4 msec or more, more favorably 8 msec or more, still more favorably 12 msec or more. The time of application of the ink of a color to the fundamental matrix is set as described above, whereby the effect of the ink used in the present invention can be fully achieved. In other words, a high-image density and high-quality image can be obtained, and high-speed ink jet recording is realized. The application of the ink of a color to the fundamental matrix is favorably conducted by a plurality of nozzle rows in the same recording head in all timings for achieving such timings of application.

An ink and an ink jet recording apparatus according to the present invention will now be described.

### <Ink>

### (Coloring Material)

In an ink used in the present invention, a self-dispersion pigment is used as a coloring material. An ink set upon formation of an image with inks of plural colors is basically composed of black, cyan, magenta and yellow inks. However, red, blue, green, gray, light cyan and light magenta inks may also be added. Pigments contained in these inks are also favorably self-dispersion pigments. When a self-dispersion pigment is used in the image forming process of the present invention, good water resistance is exhibited. In addition, the self-dispersion pigment develops a synergistic effect with a water-soluble compound used in combination in the present invention to smoothly promote solid-liquid separation after an ink impacts on paper, thereby achieving excellent color developability. When the self-dispersion pigment is used in the present invention, the pigment acts synergistically with the conditions for application of the ink, whereby solid-liquid separation is smoothly caused compared with, for example, the case of using a polymer dispersion pigment, and the pigment itself is hard to deeply permeate in the interior of plain paper, so that the color developability is remarkably improved.

The self-dispersion pigment is a pigment which does basically not essentially require a dispersant and is water-solubilized by introducing a water-soluble functional group into the surface of the pigment directly or through another atomic group. As pigments before the water-solubilization, may be used various pigments.

As a pigment used in a black ink, carbon black is favorably used. Examples of carbon black include carbon black pigments such as furnace black, lamp black, acetylene black and channel black. Such a carbon black pigment favorably has the following characteristics: the primary particle size is 15 nm or more and 40 nm or less; the specific surface area is 50 m²/g or more and 400 m²/g or less as determined according to the BET method; the DBP oil absorption is 40 ml/100 g or more and 200 ml/100 g or less; and the volatile matter content is 0.5% by weight or more and 10% by weight of less.

As pigments used in color inks, organic pigments are favorably used. As specific examples thereof, may be mentioned the following pigments: insoluble azo pigments such as Toluidine Red, Toluidine Maroon, Hansa Yellow, Benzidine Yellow and Pyrazolone Red; water-soluble azo pigments such as Lithol Red, Helio Bordeaux, Pigment Scarlet and Permanent Red 2B; derivatives from vat dyes, such as alizarin, indanthron and Thioindigo Maroon; phthalocyanine pigments such as Phthalocyanine Blue and Phthalocyanine Green; quinacridone pigments such as Quinacridone Red and Quinacridone Magenta; perylene pigments such as Perylene Red and Perylene Scarlet; isoindolinone pigments such as Isoindolinone Yellow and Isoindolinone Orange; imidazolone pigments such as Benzimidazolone Yellow, Benzimidazolone Orange and Benzimidazolone Red; pyranthrone pigments such as Pyranthrone Red and Pyranthrone Orange; thioindigo pigments; condensed azo pigments; diketopyrrolopyrrole pigments; and other pigments such as Flavanthrone Yellow, Acylamide Yellow, Quinophthalone Yellow, Nickel Azo Yellow, Copper Azomethine Yellow, Perinone Orange, Anthrone Orange, Dianthraquinonyl Red and Dioxazine Violet.

When organic pigments are indicated by COLOR INDEX (C.I.) numbers, the following pigments may be exemplified. C.I. Pigment Yellow: 12, 13, 14, 17, 20, 24, 55, 74, 83, 86, 93, 97, 98, 109, 110, 117, 120, 125, 128, 137, 138, 139, 147, 148, 150, 151, 153, 154, 155, 166, 168, 180 and 185; C.I. Pigment Orange: 16, 36, 43, 51, 55, 59, 61 and 71; C.I. Pigment Red: 9, 48, 49, 52, 53, 57, 97, 122, 123, 149, 168, 175, 176, 177, 180, 192, 202, 209, 215, 216, 217, 220, 223, 224, 226, 227, 228, 238, 240, 254, 255 and 272; C.I. Pigment Violet: 19, 23, 29, 30, 37, 40 and 50; C.I. Pigment Blue: 15, 15:1, 15:3, 15:4, 15:6, 22, 60 and 64; C.I. Pigment Green: 7 and 36; and C.I. Pigment Brown: 23, 25 and 26. Among these pigments, the following pigments are more favorable. C.I. Pigment Yellow: 13, 17, 55, 74, 93, 97, 98, 110, 128, 139, 147, 150, 151, 154, 155, 180 and 185 as yellow pigments; C.I. Pigment Red: 122, 202 and 209, and C.I. Pigment Violet 19 as magenta pigments; and C.I. Pigment Blue: 15:3 and 15:4 as cyan pigments. Needless to say, other pigments than the above-mentioned pigments may also be used.

A hydrophilic group introduced into a self-dispersion pigment prepared from any of the pigments described above as a raw material may be bonded directly to the surface of the pigment. Alternatively, the hydrophilic group may be bonded indirectly to the surface of the pigment by interposing another atomic group between the surface of the pigment and the hydrophilic group. Examples of an anionic functional group introduced and bonded include the following groups: hydrophilic groups such as —COO(M), —SO₃(M) and —PO₃(M)₂ (wherein M in the formulae is a hydrogen atom, alkali metal, ammonium or organic ammonium). Specific examples of the alkali metal represented by “M” in the hydrophilic groups include Li, Na, K, Rb and Cs. Specific examples of the organic ammonium include methylammonium, dimethylammonium, trimethylammonium, ethylammonium, diethylammonium, triethylammonium, monohydroxymethyl(ethyl)ammonium, dihydroxymethyl(ethyl)ammonium, trihydroxymethyl(ethyl)-ammonium and triethanolammonium. Among others, ammonium is particularly favorable for improvement in color developability and small letter quality. Specific examples of another atomic group interposed include linear or branched alkylene groups having 1 to 12 carbon atoms, a substituted or unsubstituted phenylene group and a substituted or unsubstituted naphthylene group. Examples of substituents on the phenylene group and naphthylene group include linear or branched alkyl groups having 1 to 6 carbon atoms. Specific examples of combinations of another atomic group and the hydrophilic group include —C₂H₄—COO(M), -Ph-SO₂(M), -Ph-COO(M) and -Ph-PO₃(M) (wherein Ph is a phenyl group).

Specific examples of production processes for introducing an anionic functional group into the surface of the pigment include a method of subjecting carbon black to an oxidizing treatment. Specific examples of the oxidizing treatment includes those using hypochlorites, ozone water, hydrogen peroxide, chlorites, nitric acid, or the like. Among others, a self-dispersion carbon black that is obtained by a surface treatment method using sodium hypochlorite is preferable in terms of color developability. Other examples of production processes for introducing an anionic functional group into the surface of the pigment include a surface treatment method using diazonium salts as disclosed in Japanese Patent No. 3808504, WO 2007/027625, and WO 2007/053564. Examples of commercially available pigments subjected to a treatment to introduce hydrophilic functional groups to the surface include pigments of the BONJET series such as BONJET BLACK CW-1, CW-2, CW-3 and so on (products of Orient Co.); pigments of the CAB-O-JET series such as CAB-O-JET 200, 300, 400, and so on (products of Cabot Co.); etc., all of which can be used as the pigment of the present invention.

When a cationic group is introduced as the water-soluble group, such a cationic group is favorably composed of, for example, at least one aromatic group of phenyl, benzyl, phenacyl and naphthyl groups or a heterocyclic group such as a pyridyl group and at least one cationic group. The cationic group bonded to the surface of carbon black is more favorably a quaternary ammonium group.

The average particle size of the self-dispersion pigment used in the present invention is determined by a dynamic light scattering method in liquid and is favorably 60 nm or more, more favorably 70 nm or more, still more favorably 75 nm or more. The average particle size is favorably 145 nm or less, more favorably 140 nm or less, still more favorably 130 nm or less. In terms of a specific method for measuring the average particle size, the average particle size can be measured by means of FPAR-1000 (manufactured by Otsuka Electronics Co., Ltd.; analysis by a cumulant method) or Nanotrac UPA 150EX (manufactured by NIKKISO; measured as a 50% cumulative value) utilizing scattering of laser beam. Incidentally, the average particle size is defined as a scattering average particle size in the present invention.

Two or more pigments may be used in combination in the same ink as needed.

The amount of the above-described self-dispersion pigment added into an ink is favorably 0.5% by mass or more, more favorably 1% by mass or more, still more favorably 2% by mass or more, based on the total mass of the ink. The amount is favorably 15% by mass or less, more favorably 10% by mass or less, still more favorably 8% by mass or less.

### (Organic Carboxylic Acid Salt)

The ink used in the present invention contains an organic carboxylic acid salt. Image density and letter quality upon printing of small letters are particularly improved by containing the organic carboxylic acid salt. The reason for it is considered to be as follows. When the organic carboxylic acid salt is used in combination, the organic carboxylic acid salt promotes deposition of the pigment after ink droplets are applied into a recording medium, so that solid-liquid separation caused between the pigment and an aqueous medium is promoted. As a result, the pigment is fixed to the surface layer of the recording medium, which can contribute to high color developing. Since the time from the arrival of the ink droplets at plain paper to the fixing thereof is shortened, bleeding can be inhibited, and letter quality upon printing of small letters is improved. In addition, power for hiding a sizing agent scatteringly present in the surface of plain paper strengthens, and so an effect to prevent the so-called blank area phenomenon at a solid print portion is observed.

No particular limitation is imposed on the organic carboxylic acid salt so far as it is a salt of a carboxylic acid with 1 to 3 carboxyl groups bonded to a skeleton having carbon atom(s). Specific examples of the salt with the carboxylic acid include salts with citric acid, succinic acid, benzoic acid, acetic acid, propionic acid, phthalic acid, oxalic acid, tartaric acid, gluconic acid, tartronic acid, maleic acid, malonic acid, adipic acid and derivatives thereof. Among others, salts with dicarboxylic acids such as phthalic acid, succinic acid, adipic acid, tartaric acid and maleic acid are favorable, and salts with phthalic acid are particularly favorable. Other favorable organic carboxylic acid salts include salts with aromatic carboxylic acids such as benzoic acid and phthalic acid. The pKa value of the organic carboxylic acid is favorably 2.5 or more and 5.5 or less. When an organic carboxylic acid has 2 or more carboxyl groups, at least one carboxyl group of such a carboxylic acid favorably has a pKa value of 2.5 or more and 5.5 or less. These organic carboxylic acid salts are used in combination, whereby the effect by the recording method according to the present invention is increased.

As a counter ion for forming the salt, an alkali metal, ammonium or organic ammonium may be used like the case of the counter ion in the self-dispersion pigment. The same counter ion as the counter ion in the self-dispersion pigment added to the same ink is favorably used as the counter ion of the organic carboxylic acid.

Specific examples of the alkali metal as the counter ion include Li, Na, K, Rb and Cs. Specific examples of the organic ammonium include methylammonium, dimethylammonium, trimethylammonium, ethylammonium, diethylammonium, triethylammonium, monohydroxymethyl-(ethyl)ammonium, dihydroxymethyl(ethyl)ammonium, trihydroxymethyl(ethyl)ammonium and triethanolammonium. The ammonium salts of the organic carboxylic acids are particularly favorable for improvement in color developability and small letter quality.

The amount of the organic carboxylic acid salt added into the ink is favorably 0.05% by mass or more, more favorably 0.1% by mass or more, still more favorably 0.2% by mass or more. The amount is favorably 3% by mass or less, more favorably 2% by mass or less, still more favorably 1% by mass or less.

### (Aqueous Medium)

The ink according to the present invention contains water as an essential component, and the content of water in the ink is favorably 30% by mass or more based on the total mass of the ink. The content is favorably 95% by mass or less. In addition to water, a water-soluble compound is allowed to be contained to provide an aqueous medium. The water-soluble compound is miscible with water without undergoing phase separation from water in the form of a 20% by mass mixed liquid with water and is high in hydrophilicity. Any water-soluble compound easy to evaporate is not favorable from the viewpoints of solid-liquid separation and the prevention of clogging, and a substance having a vapor pressure of 0.04 mmHg or less at 20° C. is favorable.

The ink according to the present invention contains, as an essential component, a water-soluble compound having a hydrophilicity-hydrophobicity coefficient of 0.26 or more as defined by the following equation (A). According to a recording medium used, an ink containing a water-soluble compound having a hydrophilicity-hydrophobicity coefficient of 0.26 or more and 0.37 or less as defined by the equation (A) and a water-soluble compound having a hydrophilicity-hydrophobicity coefficient of 0.37 or more is favorable because printing characteristics for small letters are improved. According to a recording medium used, it may be more favorable in some cases to contain a water-soluble compound having a hydrophilicity-hydrophobicity coefficient of from 0.26 or more to 0.37 or less and two or more water-soluble compounds each having a hydrophilicity-hydrophobicity coefficient of 0.37 or more, since printing characteristics for small letters are improved. The reason for it is considered to be as follows. These water-soluble compounds having a hydrophilicity-hydrophobicity coefficient of 0.37 or more show a comparatively small affinity for water, the self-dispersion pigment and cellulose fibers after the ink impacts on paper, and so the compounds have the role of strongly promoting solid-liquid separation of the self-dispersion pigment. Therefore, the above-described effect is exhibited according to the recording medium used.

Hydrophilicity-hydrophobicity coefficient=[(Water activity of a 20% aqueous solution)−(Molar fraction of water in the 20% aqueous solution)]/[1−(Molar fraction of water in the 20% aqueous solution)] Equation (A)

The water activity in the equation is represented by [Water activity=(Water vapor pressure of an aqueous solution)/(Water vapor pressure of pure water)]. Various methods are present as methods for measuring the water activity. Although the method is not limited to any method, a chilled mirror dew point measuring method among others is suitable for use in measurement of materials used in the present invention. The values in the present description are obtained by subjecting a 20% aqueous solution of each water-soluble compound to measurement at 25° C. by means of AQUALOVE CX-3TE (manufactured by DECAGON Co.) according to this measuring method.

According to the Raoult's Law, a rate of vapor pressure depression of a dilute solution is equal to a molar fraction of a solute and has no connection with the kinds of a solvent and a solute, so that the molar fraction of water in an aqueous solution is equal to the water activity. However, when water activities of aqueous solutions of various water-soluble compounds are measured, the water activities do often not consist with the molar fraction of water.

When the water activity of an aqueous solution is lower than the molar fraction of water, the water vapor pressure of the aqueous solution comes to be smaller than the theoretical calculated value, and evaporation of water is inhibited by presence of a solute. From this fact, it is found that the solute is a substance great in hydration force. When the water activity of an aqueous solution is higher than the molar fraction of water to the contrary, a solute is considered to be a substance small in hydration force.

The present inventors have paid attention to the feature that the degree of hydrophilicity or hydrophobicity of a water-soluble compound contained in an ink greatly affects the promotion of solid-liquid separation between a self-dispersion pigment and an aqueous medium and the performance of various inks. From this feature, the hydrophilicity-hydrophobicity coefficient represented by the equation (A) has been defined. The water activity is measured on aqueous solutions of various water-soluble compounds at a fixed concentration of 20% by mass. The degree of hydrophilicity or hydrophobicity between various solutes can be relatively compared by conversion to the equation (A) even when the molecular weights of the solutes and the molar fractions of water are different. Since the water activity of an aqueous solution does not exceed 1, the maximum value of the hydrophilicity-hydrophobicity coefficient is 1.

The hydrophilicity-hydrophobicity coefficients of water-soluble compounds, which are obtained according to the equation (A), are shown in Table 1. However, the water-soluble compounds of the present invention are not limited only to these compounds.

TABLE 1

| | Hydrophilicity- |
|---|---|
| Substance name | hydrophobicity coefficient |
| 1,2-Hexanediol | 0.97 |
| 1,2-Pentanediol | 0.93 |
| 3-Methyl-1,3-butanediol | 0.90 |
| 1,2-Butanediol | 0.90 |
| 2,4-Pentanediol | 0.88 |
| 1,6-Hexanediol | 0.76 |
| 1,7-Heptanediol | 0.73 |
| 3-Methyl-1,5-pentanediol | 0.54 |
| 1,5-Pentanediol | 0.41 |
| Trimethylolpropane | 0.31 |
| Ethyleneurea | 0.30 |
| 1,2,6-Hexanetriol | 0.28 |
| 1,2,3-Butanetriol | 0.22 |
| Sorbitol | 0.21 |
| Urea | 0.20 |
| Diethylene glycol | 0.15 |
| 1,2,4-Butanetriol | 0.15 |
| Glycerol | 0.11 |
| Diglycerol | 0.08 |
| Triethylene glycol | 0.07 |
| Polyethylene glycol 200 | −0.09 |
| Polyethylene glycol 600 | −0.43 |

As the water-soluble compound, a water-soluble compound having the intended hydrophilicity-hydrophobicity coefficient can be selected for use from among various kinds of water-soluble compounds having suitability for ink jet recording inks.

The present inventors have carried out an investigation as to the relationship between water-soluble compound(s) contained in the ink and printing characteristics for small letters, such as bleeding and dot gain, in the ink jet image forming method according to the present invention. As a result, it has been found that when a water-soluble compound having a hydrophilicity-hydrophobicity coefficient of 0.26 or more and having a low hydrophilic tendency is used in the ink containing the self-dispersion pigment and the organic carboxylic acid salt according to the present invention, the above-mentioned characteristics are extremely improved. Among others, compounds having such a glycol structure that the number of carbon atoms unsubstituted on a hydrophilic group in the glycol structure is more than the number of carbon atoms substituted on the hydrophilic group were particularly favorable. It is considered that these water-soluble compounds are comparatively small in affinity for water, the self-dispersion pigment and cellulose fibers after the ink impacts on paper, and so the compounds have the role of strongly promoting solid-liquid separation of the self-dispersion pigment.

When the water-soluble compound having a hydrophilicity-hydrophobicity coefficient of 0.26 or more is used singly, trimethylolpropane is particularly favorable. When the water-soluble compound having a hydrophilicity-hydrophobicity coefficient of 0.37 or more is used in combination, diols having 4 to 7 carbon atoms, such as hexanediol, pentanediol and butanediol, are favorable as such water-soluble compounds. Diols having 6 carbon atoms are more favorable, with 1,2-hexanediol and 1,6-hexanediol being particularly favorable. With respect to the mixing ratio when 2 or more water-soluble compounds having a hydrophilicity-hydrophobicity coefficient of 0.37 or more are allowed to be contained, 1,2-hexanediol and 1,6-hexanediol are favorably used at a ratio of from 1/10 to 10/1. 1,2-Hexanediol and 1,6-hexanediol are more favorably used at a ratio of from 1/5 to 5/1. When 2 or more water-soluble compounds having a hydrophilicity-hydrophobicity coefficient of 0.37 or more are used, the difference between the hydrophilicity-hydrophobicity coefficients thereof is favorably 0.1 or more.

The total content of the water-soluble compound(s) in the ink is favorably 5% by mass or more, more favorably 6% by mass or more, still more favorably 7% by mass. The total content is favorably 40% by mass or less, more favorably 35% by mass or less, still more favorably 30% by mass or less. When water-soluble compound(s) having a hydrophilicity-hydrophobicity coefficient of 0.37 or more are used in combination, the total content of the water-soluble compound(s) is favorably 3% by mass or more, more favorably 5% by mass or more.

### (Surfactant)

The ink used in the present invention favorably contains a surfactant for achieving ejection stability with good balance. In particular, the ink favorably contains a nonionic surfactant. Among nonionic surfactants, polyoxyethylene alkyl ethers and ethylene oxide adducts of acetylene glycol are particularly favorable. The HLB (hydrophile-lipophile balance) values of these nonionic surfactants are 10 or more. The content of the surfactant used in the ink in combination is favorably 0.1% by mass or more, more favorably 0.3% by mass or more, still more favorably 0.5% by mass or more. The content is favorably 5% by mass or less, more favorably 4% by mass or less, still more favorably 3% by mass or less.

### (Other Additives)

Besides the above-described components, a viscosity modifier, an antifoaming agent, a preservative, a mildew-proofing agent, an antioxidant and a penetrant may be added as additives to the ink according to the present invention, as needed, to provide the ink as an ink having desired physical property values.

### (Surface Tension)

The surface tension of the ink used in the present invention is 34 mN/m or less. The surface tension of the ink is favorably 33 mN/m or less, more favorably 32 mN/m or less. The surface tension is favorably 27 mN/m or more, more favorably 28 mN/m or more, still more favorably 29 mN/m. The surface tension of the ink is controlled within this range, thereby fully exhibiting the effects of the ink. Incidentally, the surface tension is a value measured by the vertical plate method, and CBVP-Z (manufactured by Kyowa Interface Science Co., Ltd.) is mentioned as a specific measuring apparatus.

Since glossy paper and mat paper that are exclusive paper for ink jet have a porous ink receiving layer formed on the surface of paper unlike plain paper, such paper is scarcely affected by the surface tension of an ink so that permeation of the ink quickly progresses.

However, a sizing agent having a water-repellent effect is internally and/or externally added to plain paper, so that the permeation of an ink is often inhibited. In other words, the plain paper has a lower critical surface tension, which is an index as to whether the surface can be rapidly wetted with the ink or not, than the exclusive paper for ink jet.

When the surface tension of the ink is higher than 34 mN/m, such surface tension is higher than the critical surface tension of the plain paper, so that the plain paper is not immediately wetted even when the ink impacts the paper, and permeation of the ink is not rapidly started. When the surface tension of the ink is high, such an ink is hard to be fixed in a short time even when wettability with paper is somewhat improved to lower the contact angle between the ink and the paper. Further, such an ink tends to deteriorate the fixability thereof. When the surface tension of the ink is 34 mN/m or less, pore absorption is mainly caused. When the surface tension of the ink is higher than 34 mN/m, fiber absorption is mainly caused. With respect to the absorption rate of an ink into paper by absorption of these two types, the pore absorption is overwhelmingly faster. Thus, an ink that mainly causes pore absorption in the present invention provides the ink which can be fixed in a short time.

### (Viscosity)

The viscosity of the ink used in the present invention is favorably 6.0 mPa·s or less. When an ink jet recording apparatus in which ink jet recording is conducted by utilizing thermal energy is used, the feed of the ink to a nozzle may not be in time in some cases to record an unclear image when the viscosity is higher than the above viscosity. The viscosity of the ink is more favorably 5.0 mPa·s or less, still more favorably 4.0 mPa·s or less.

### <Ink Jet Recording Apparatus>

The ink jet recording apparatus according to the present invention is then described. The ink jet recording apparatus according to the present invention is an apparatus equipped with a recording head for applying an ink droplet in a fixed amount of 0.5 pl or more and 6 pl or less. The recording head of the ink jet recording apparatus according to the present invention is favorably a recording head in which thermal energy is caused to act on an ink to apply the ink. Such a recording head is suitable for forming nozzles at a high density compared with a recording head in which an ink is ejected by using a piezoelectric element. In addition, such a recording head is excellent in applying the ink in a fixed amount and thus excellent in that variation in permeation depth of the ink is reduced and the uniformity of the resulting recorded image is made good.

With respect to the typical construction and principle of the recording head in which thermal energy is caused to act on the ink to apply the ink, those using the basic principle disclosed in, for example, U.S. Pat. Nos. 4,723,129 and 4,740,796 are favorable. This system may be applied to any of the so-called On-Demand type and continuous type. In particular, the On-Demand type is advantageous. In the case of the On-Demand type, at least one driving signal, which corresponds to recording information and gives a rapid temperature rise exceeding nuclear boiling, is applied to an electrothermal converter arranged corresponding to a sheet or a liquid path, in which an ink is retained, thereby causing the electrothermal converter to generate thermal energy to cause film boiling on the heat-acting surface of a recording head. As a result, a bubble can be formed in the ink in response to the driving signal in relation of one to one. The ink is ejected through an ejection opening by the growth-contraction of this bubble to form at least one droplet. When the driving signal is applied in the form of a pulse, the growth-contraction of the bubble is suitably conducted in a moment, so that the amount of the ink ejected is fixed, and the ejection of the ink, which is also excellent in responsiveness, can be achieved. It is therefore favorable to use such pulsed signals.

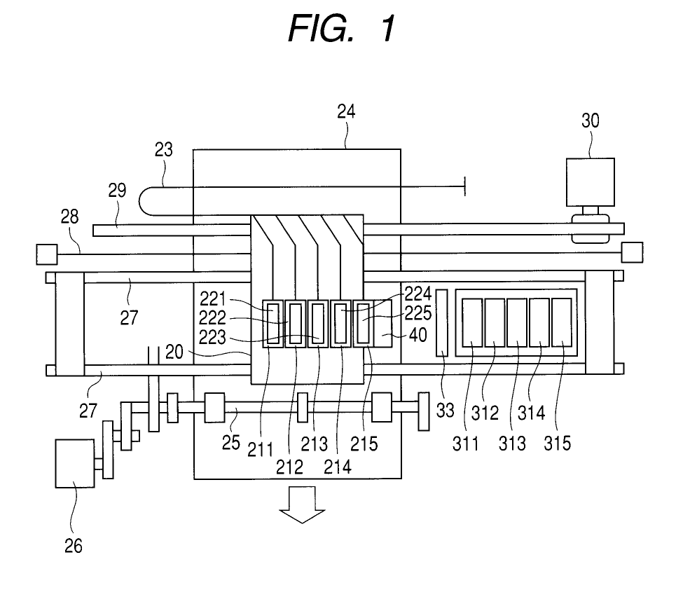

FIG. 1 is a front elevation schematically illustrating an ink jet recording apparatus according to an embodiment of the present invention. A recording head, which conducts ejection by an ink jet recording system, is mounted on a carriage 20. The recording head has nozzle rows 211 to 215 as a plurality of nozzle rows. As an embodiment of the construction that a black ink is applied by 2 divisions and in 1-pass, is mentioned an embodiment in which nozzle rows 211, 212, 213, 214 and 215 eject black (K), cyan (C), magenta (M), yellow (Y) and black (K) inks, respectively.

Ink cartridges 221 to 225 are respectively constructed by the recording head, nozzle rows 211 to 215 and ink tanks for feeding inks to these orifices.

A concentration sensor 40 is provided. The concentration sensor 40 is a reflection type concentration sensor and is so constructed that the density of a test pattern recorded on a recording medium can be detected in a state of being provided on a side surface of the carriage 20.

Control signals to the recording head are transferred through a flexible cable 23.

A recording medium 24, to the surface of which cellulose fiber is exposed, such as plain paper, is held by discharge rollers 25 via conveyance rollers (not illustrated) and conveyed in a direction (secondary scanning direction) of the arrow by driving a conveyance motor 26.

The carriage 20 is guided and supported by a guide shaft 27 and a linear encoder 28. The carriage 20 is reciprocatingly moved in a main scanning direction along the guide shaft 27 through a drive belt 29 by driving a carriage motor 30.

A heating element (electricity-thermal energy converter) for generating thermal energy for ink ejection is provided in the interior (liquid path) of the recording head. The heating element is driven based on a recording signal in accordance with the reading timing of the linear encoder 28 to eject and apply ink droplets on to the recording medium, thereby forming an image.

A recovery unit having cap parts 311 to 315 is provided at a home position of the carriage 20 arranged outside a recording region. When recording is not conducted, the carriage 20 is moved to the home position, and the nozzle rows 211 to 215 are closed by their corresponding caps 311 to 315, whereby sticking of the inks caused by evaporation of ink solvents or clogging by adhesion of foreign matter such as dust can be prevented. The capping function of the cap parts is also utilized for solving ejection failure or clogging of ink ejection orifices of low recording frequency. Specifically, the capping parts are utilized for blank ejection for preventing ejection failure, in which the inks are ejected to the cap parts located in a state of being separated from the ink ejection orifices. Further, the cap parts are utilized for sucking the inks from the ink ejection orifices in a capped state by a pump (not illustrated) to recover ejection of ejection orifices undergone ejection failure.

An ink receiving part 33 plays the role of receiving ink droplets preliminarily ejected when the recording head passes through over it just before recording operation. A blade or wiping member (not illustrated) is arranged at a position adjoining the cap parts, whereby faces forming the nozzle rows 211 to 215 can be cleaned.

As described above, it is favorable to add the recovery unit for the recording head and preliminary units to the construction of the recording apparatus because the recording operation can be more stabilized. Specific examples of these units include capping units, cleaning units and pressurizing or sucking units for the recording head, and preliminary heating units by electrothermal converters, other heating elements than these converters or combinations thereof. It is also effective for stably conducting recording to provide a preliminary ejection mode to conduct ejection other than that for recording.

In addition, a cartridge type recording head in which ink tanks are provided integrally with the recording head itself described in the above-described embodiment may also be used. Further, a replaceable chip type recording head in which electrical connection to an apparatus body and the feed of inks from the apparatus body become feasible by installing it in the apparatus body may also be used.

FIG. 3 illustrates the construction of the recording head having the nozzle rows 211 to 215. In the drawing, the recording scan directions of the recording head are directions indicated by the arrows. The nozzle rows 211 to 215 each composed of a plurality of nozzles arranged in a direction substantially perpendicular to the recording scan direction are provided in the recording head. The recording head ejects ink droplets at a predetermined timing from the respective ejection orifices while being moved and scanned in the recording scan direction in the drawing, whereby an image is formed on a recording medium at a recording resolution according to the arrangement density of the nozzles. At this time, the recording head may conduct recording operation in any direction of the recording scan directions. The recording operation may be conducted in any direction of the forward and return directions.

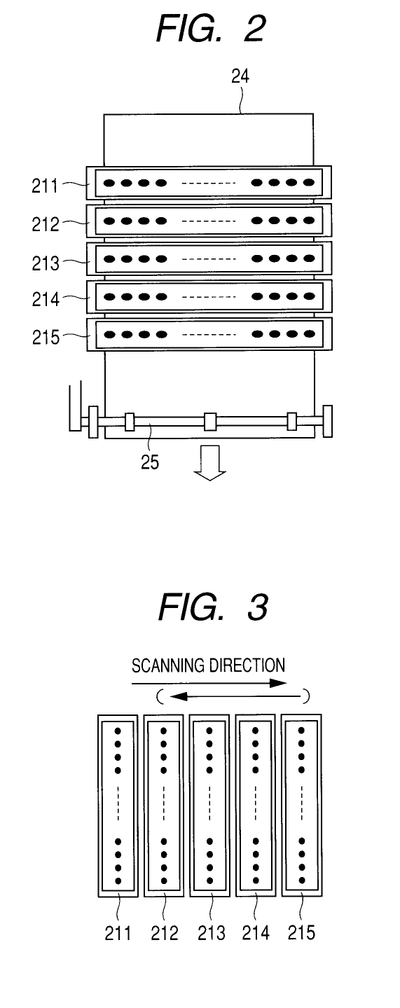

The above-described embodiment is directed to a recording apparatus of a serial type in which the recording head is scanned to conduct recording. However, a recording apparatus of a full-line type that a recording head having a length corresponding to the width of a recording medium is used may also be used. As the recording head of the full-line type, is mentioned such a construction that such recording heads of the serial type as disclosed in FIG. 3 are arranged in a zigzag state or in parallel to form a continuous recording head so as to give the intended length. Alternatively, such a construction (FIG. 2) that one recording head integrally formed so as to have a continuous nozzle row is used may also be adopted.

The above-described recording apparatus of the serial type or line type is an example where a head independently or integrally formed for 4 color inks (Y, M, C and K) is used, or an example where a head of the construction of 5 ejection orifice rows (or nozzle rows) in which black ink nozzle rows 211 and 215 are respectively provided for applying only a black ink by 2 divisions is installed. It is also favorable as a mode suitable for dividing the number of applications into about 2 to 12 using 4 nozzle rows to duplicatively mount inks of the same color as to at least one ink of 4 color inks (Y, M, C and K) in plural nozzle rows. For example, construction of 8 nozzle rows or construction of 12 nozzle rows in which 2 or 3 heads each having 4 nozzle rows are continuously connected is also mentioned.

As a specific example where an ink of the same color is applied at plural timings, is mentioned a mode in which the ink is applied by 2 applications in one scanning using the serial type recording apparatus. As a mode to apply the black ink by 2 applications in one scanning, the construction of a head using the recording head illustrated in FIG. 3 is described as an example. A particularly favorable mode is to eject black (K), cyan (C), magenta (M), yellow (Y) and black (K) inks by the nozzle rows 211, 212, 213, 214 and 215, respectively. The speed of the carriage, on which this recording head is mounted, and/or the widths of the 2 nozzles for the black inks are changed, whereby the time of application of the ink of one color to the fundamental matrix can be controlled within the range of 1 msec or more and 200 msec or less.

According to the ink jet recording apparatus of the present invention, when such image that the total amount of inks applied to a fundamental matrix for forming the image is 5.0 μl/cm² or less and the duty of an ink of one color is 80% duty or more is formed in the fundamental matrix, the application of the ink of a color is conducted at plural timings. In addition, the amount of the ink applied at each timing is controlled to 0.7 μl/cm² or less. Further, the time from the beginning of application of the ink to the fundamental matrix to completion of the application is controlled within a range of 1 msec or more and 200 msec or less. The ink jet recording apparatus of the present invention has a control mechanism for conducting such divided applications. The operation of the ink jet recording head and the timing of conveyance operation of plain paper are controlled by this control mechanism to conduct such divided applications.

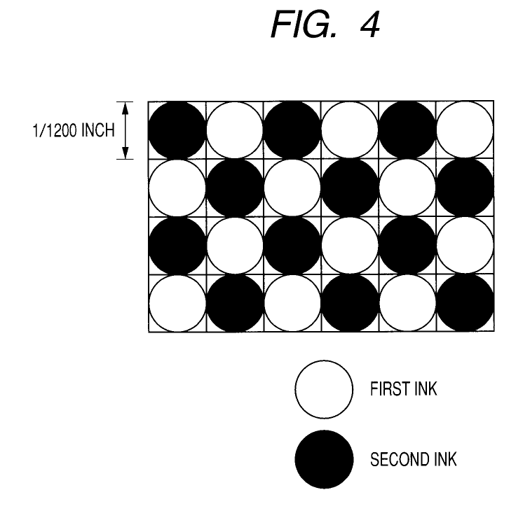

The number of divisions of the application of the ink of a color can be set according to desired recording conditions. An example where the application is divided into 2 applications is illustrated in FIG. 4. This example is an example where the resolution of a fundamental matrix is 1,200 dpi (width)×1,200 dpi (length), and an image having a portion with a duty of 100% is formed. In FIG. 4, the impact positions of the ink applied at the first time and the impact positions of the ink applied at the second time are illustrated as the first ink and the second ink, respectively. The first ink and second ink are respectively applied in a fixed amount.

### EXAMPLES

The present invention will hereinafter be described more specifically by the following Examples and Comparative Examples. Incidentally, all designations of “part” or “parts” and “%” in the following examples mean part or parts by mass and % by mass unless expressly noted. The surface tension of each ink was measured by CBVP-Z (manufactured by Kyowa Interface Science Co., Ltd.). The viscosity was measured by a RE80 type viscometer (manufactured by TOKI SANGYO CO., LTD.). The average particle size of each self-dispersion pigment was measured by Nanotrac UPA 150EX (manufactured by NIKKISO; indicating as a 50% cumulative value).

First of all, preparation processes of respective pigment dispersions contained in inks used in Examples and Comparative Examples are described.

### PREPERATION EXAMPLES

### (Preparation of Pigment Dispersion)

### <Preparation of Self-Dispersion Pigment Dispersion A>

To 3,750 g of ion-exchanged water, was added 100 g of carbon black having a specific surface area of 320 m²/g and a DBP oil absorption of 110 ml/100 g, and the resultant mixture was heated to 50° C. with stirring. Thereafter, an aqueous solution of 4,500 g of sodium hypochlorite (available chlorine concentration: 12%) was added dropwise over 3 hours at 50° C. while being pulverized by a bead mill using zirconia beads having a diameter of 0.5 mm. Thereafter, pulverization was further conducted for 30 minutes to obtain a reaction mixture containing self-dispersion carbon black. After the reaction mixture was fractionated, neutralization was conducted with aqueous ammonia, and desalting was conducted by an ultrafilter until the conductivity became 1.5 mS/cm. After the thus-treated liquid was adjusted so as to give a concentration of the self-dispersion carbon black of 10%, the liquid was filtered by using a prefilter and a filter having a pore size of 1 μm in combination to obtain Self-dispersion Pigment Dispersion.

### <Preparation of Self-Dispersion Pigment Dispersion B>

After 100 g of carbon black having a specific surface area of 220 m²/g and a DBP oil absorption of 105 ml/100 g and 34.1 g of p-aminobenzoic acid were fully mixed with 720 g of water, 16.2 g of nitric acid was added dropwise to the resultant mixture, and the mixture was stirred at 70° C. After 10 minutes, a solution with 10.7 g of sodium nitrite dissolved in 50 g of water was added thereto, and stirring was conducted for additional 1 hour. The resultant slurry was filtered through filter paper (trade name: Toyo Filter Paper No. 2; product of Advantice Co.), and the thus-filtered pigment particles were fully washed with water and dried in an oven controlled to 90° C. A self-dispersion black pigment with a p-benzoic group introduced into the surface of carbon black was obtained by the above-described process. After this pigment was adjusted with ion-exchanged water so as to give a pigment concentration of 10%, the pH thereof was adjusted to 7.5 with aqueous ammonia. The resultant dispersion was further filtered by using a prefilter and a filter having a pore size of 1 μm in combination to obtain Self-dispersion Pigment Dispersion B.

### <Preparation of Self-Dispersion Pigment Dispersion C>

Self-dispersion Pigment Dispersion C was obtained in the same manner as in the preparation of Self-dispersion Pigment Dispersion B except that C.I. Pigment Yellow 74 was used in place of carbon black.

### <Preparation of Self-Dispersion Pigment Dispersion D>

Self-dispersion Pigment Dispersion D was obtained in the same manner as in the preparation of Self-dispersion Pigment Dispersion B except that C.I. Pigment Red 122 was used in place of carbon black.

### <Preparation of Self-Dispersion Pigment Dispersion E>

Self-dispersion Pigment Dispersion E was obtained in the same manner as in the preparation of Self-dispersion Pigment Dispersion B except that C.I. Pigment Blue 15:3 was used in place of carbon black.

### (Preparation of Ink 1)

After the following components (100 parts in total) were mixed for 2 hours, the resultant mixture was filtered through a filter having a pore size of 2.5 μm to obtain Ink 1 of Example. The surface tension of the ink was 32 mN/m, the average particle size of the self-dispersion pigment was 130 nm, and the viscosity of the ink was 4.4 mPa·s.
Self-dispersion Pigment Dispersion A: 50 parts
Ammonium phthalate: 0.5 parts
Trimethylolpropane(hydrophilicity-hydrophobicity coefficient: 0.31): 20 parts
Isopropyl alcohol: 1 part
Ethylene oxide adduct of acetylene glycol (trade name: OLFINE E1010, product of Nisshin Chemical Industry Co., Ltd., HLB value: 10 or more): 1 part
Water: balance.

### (Preparation of Ink 2)

After the following components (100 parts in total) were mixed for 2 hours, the resultant mixture was filtered through a filter having a pore size of 2.5 μm to obtain Ink 2 of Example. The surface tension of the ink was 30 mN/m, the average particle size of the self-dispersion pigment was 130 nm, and the viscosity of the ink was 3.5 mPa·s.
Self-dispersion Pigment Dispersion A: 50 parts
Ammonium phthalate: 0.5 parts
Trimethylolpropane (hydrophilicity-hydrophobicity coefficient: 0.31): 15 parts
1,2-Hexanediol(hydrophilicity-hydrophobicity coefficient: 0.97): 5 parts
Isopropyl alcohol: 1 part
Ethylene oxide adduct of acetylene glycol (trade name: OLFINE E1010, product of Nisshin Chemical Industry Co., Ltd., HLB value: 10 or more): 1 part
Water: balance.

### (Preparation of Ink 3)

After the following components (100 parts in total) were mixed for 2 hours, the resultant mixture was filtered through a filter having a pore size of 2.5 μm to obtain Ink 3 of Example. The surface tension of the ink was 31 mN/m, the average particle size of the self-dispersion pigment was 130 nm, and the viscosity of the ink was 3.5 mPa·s.
Self-dispersion Pigment Dispersion A: 50 parts
Ammonium phthalate: 0.5 parts
Trimethylolpropane(hydrophilicity-hydrophobicity coefficient: 0.31): 10 parts
1,2-Hexanediol(hydrophilicity-hydrophobicity coefficient: 0.97): 5 parts
1,6-Hexanediol(hydrophilicity-hydrophobicity coefficient: 0.76): 5 parts
Isopropyl alcohol: 1 part
Ethylene oxide adduct of acetylene glycol (trade name: OLFINE E1010, product of Nisshin Chemical Industry Co., Ltd., HLB value: 10 or more): 1 part
Water: balance.

### (Preparation of Ink 4)

Ink 4 was obtained in the same manner as in the preparation of Ink 2 except that Self-dispersion Pigment Dispersion A was changed to Self-dispersion Pigment Dispersion B. The surface tension of the ink was 29 mN/m, the average average particle size of the self-dispersion pigment was 110 nm, and the viscosity of the ink was 3.1 mPa·s.

### (Preparation of Ink 5)

Ink 5 was obtained in the same manner as in the preparation of Ink 1 except that the content of the ethylene oxide adduct of acetylene glycol was changed from 1 part to 0.1 part. The surface tension of the ink was 40 mN/m, and the average particle size of the self-dispersion pigment was 120 nm.

### (Preparation of Ink 6)

Ink 6 was obtained in the same manner as in the preparation of Ink 2 except that ammonium phthalate was not added. The surface tension of the ink was 30 mN/m, and the average particle size of the self-dispersion pigment was 130 nm.

### (Preparation of Ink 7)

Ink 7 was obtained in the same manner as in the preparation of Ink 1 except that trimethylolpropane was changed to glycerol (hydrophilicity-hydrophobicity coefficient: 0.11). The surface tension of the ink was 29 mN/m, and the average particle size of the self-dispersion pigment was 130 nm.

### (Preparation of Ink 8)

Ink 8 was obtained in the same manner as in the preparation of Ink 2 except that Self-dispersion Pigment Dispersion A (50 parts) was changed to Self-dispersion Pigment Dispersion C (40 parts). The surface tension of the ink was 29 mN/m, and the average particle size of the self-dispersion pigment was 125 nm.

### (Preparation of Ink 9)

Ink 9 was obtained in the same manner as in the preparation of Ink 2 except that Self-dispersion Pigment Dispersion A (50 parts) was changed to Self-dispersion Pigment Dispersion D (40 parts). The surface tension of the ink was 29 mN/m, and the average particle size of the self-dispersion pigment was 85 nm.

### (Preparation of Ink 10)

Ink 10 was obtained in the same manner as in the preparation of Ink 2 except that Self-dispersion Pigment Dispersion A (50 parts) was changed to Self-dispersion Pigment Dispersion E (40 parts). The surface tension of the ink was 29 mN/m, and the average particle size of the self-dispersion pigment was 105 nm.

### Examples 1 to 16, and Comparative Examples 1 to 7

Inks 1 to 10 were used to form images of Examples 1 to 14 and Comparative Examples 1 to 5 under conditions shown in Table 2. Table 2 shows examples where the amount of the ink applied to an image was divided into equal amounts at respective applications. Table 3 shows examples where the amount of the ink applied to an image was changed at respective applications. The total amount applied is the total amount of the ink applied to a fundamental matrix of the image up to the final formation of the image.

Office Planner Paper (product of Canon Marketing Japan Inc.) that is plain paper for PPC/BJ common use was used for evaluation of recorded images. An ink jet recording apparatus used is the following apparatus.
F930 (manufactured by Canon Inc.; recording head: 6 nozzle rows, including 512 nozzles in each row; droplets volume of the ink: 4.0 pl (fixed amount); maximum resolution: 1,200 dpi (width)×1,200 dpi (length); hereinafter referred to as “Printer A”).

In this example of image formation, the resolution of a fundamental matrix was set to 1,200 dpi×1,200 dpi for Printer A. In the case of 1-pass printing, an ink tank into which the ink of the present invention had been charged was mounted in a black ink mounting part among the 6 nozzle rows of the recording head. In the case of divided printing, 2 to 4 nozzle rows were used to eject the ink by dividing the application of the ink into plural times and apply the total amount of the ink by one scanning, thereby recording a printed image of 100% duty.

TABLE 2

| | | | Time required | Amount applied | Total |
|---|---|---|---|---|---|
| | | Number | from beginning of | at each | amount |
| | | of divi- | application to | application | applied |
| | Ink | sions | completion (msec) | (μl/cm²) | (μl/cm²) |
| Ex. 1 | 1 | 2 | 12 | 0.5 | 1 |
| Ex. 2 | 2 | 2 | 4 | 0.5 | 1 |
| Ex. 3 | 2 | 2 | 8 | 0.5 | 1 |
| Ex. 4 | 2 | 2 | 12 | 0.5 | 1 |
| Ex. 5 | 2 | 2 | 20 | 0.5 | 1 |
| Ex. 6 | 2 | 2 | 50 | 0.5 | 1 |
| Ex. 7 | 2 | 2 | 20 | 0.7 | 1.4 |
| Ex. 8 | 2 | 3 | 20 | 0.33 | 1 |
| Ex. 9 | 2 | 4 | 20 | 0.25 | 1 |
| Ex. 10 | 3 | 2 | 12 | 0.5 | 1 |
| Ex. 11 | 4 | 2 | 12 | 0.5 | 1 |
| Ex. 12 | 8 | 2 | 12 | 0.5 | 1 |
| Ex. 13 | 9 | 2 | 12 | 0.5 | 1 |
| Ex. 14 | 10 | 2 | 12 | 0.5 | 1 |
| Comp. | 1 | One-pass printing* | | 1 | 1 |
| Ex. 1 | | | | | |
| Comp. | 5 | 2 | 12 | 0.5 | 1 |
| Ex. 2 | | | | | |
| Comp. | 6 | 2 | 12 | 0.5 | 1 |
| Ex. 3 | | | | | |
| Comp. | 7 | 2 | 12 | 0.5 | 1 |
| Ex. 4 | | | | | |

| | | | | |
|---|---|---|---|---|
| Comp. | 4 | One-pass printing* | 1 | 1 |
| Ex. 5 | | | | |

*One-pass printing: a printing method in which the total amount of an ink for forming an image is ejected from one nozzle row by one scanning to form the image.

TABLE 3

| | | | Time required | Amount applied | | |
|---|---|---|---|---|---|---|
| | | | from beginning | at each | | Total |
| | | | of application | application | | amount |
| | | Number of | to completion | (μl/cm² ) | | applied |
| | Ink | divisions | (msec) | First | Second | (μl/cm² ) |
| Ex. | 2 | 2 | 20 | 0.6 | 0.4 | 1 |
| 15 | | | | | | |
| Ex. | 2 | 2 | 20 | 0.4 | 0.6 | 1 |
| 16 | | | | | | |
| Comp. | 2 | 2 | 20 | 0.75 | 0.25 | 1 |
| Ex. 6 | | | | | | |
| Comp. | 2 | 2 | 20 | 0.25 | 0.75 | 1 |
| Ex. 7 | | | | | | |

The recorded images of Examples 1 to 16 and Comparative Examples 1 to 7 were evaluated as to image density (O.D.) and small letter printing. The results are shown in Table 4. Evaluation as to images was made by using a black head and printing an image (3 cm×3 cm) of 100% duty and JIS first level Chinese letters of 5 point as small letters. Incidentally, the images were evaluated according to the following respective evaluation methods and criteria.

### (Image Density)

As to the images of black inks, O.D. of a solid print image of 100% duty was measured by a densitometer (Macbeth RD915; manufactured by Macbeth Co.).
A: O.D. was 1.40 or more;
B: O.D. was 1.35 or more and less than 1.40;
C: O.D. was 1.30 or more and less than 1.35;
D: O.D. was less than 1.30.

### (Fixability)

After 10 seconds from the printing of the solid print image of 100% duty, silbon paper was pressed against the print to visually evaluate the degree of transfer according to the following evaluation criteria.
A: No transfer is observed;
B: Transfer is slightly observed;
C: Transfer is clearly observed.

### (Small Letter Printing)

The sharpness of small letters (Chinese letters) printed was visually evaluated according to the following evaluation criteria.
A: Disorder of outlines is not observed even in complex small letters;
B: Outlines are slightly disordered in complex small letters;
C: Outlines are disordered in complex small letters;
D: Disorder was observed even in simple small letters in some cases.

TABLE 4

| | Image | | Small letter |
|---|---|---|---|
| | density | Fixability | printing |
| Ex. 1 | A | A | A |
| Ex. 2 | B | A | A |
| Ex. 3 | A | A | A |
| Ex. 4 | A | A | A |
| Ex. 5 | A | A | A |
| Ex. 6 | A | A | A |
| Ex. 7 | A | A | B |
| Ex. 8 | A | A | A |
| Ex. 9 | A | A | A |
| Ex. 10 | A | A | A |
| Ex. 11 | A | A | A |
| Ex. 12 | — | A | A |
| Ex. 13 | — | A | A |
| Ex. 14 | — | A | A |
| Ex. 15 | B | A | A |
| Ex. 16 | B | A | A |
| Comp. Ex. 1 | B | A | C |
| Comp. Ex. 2 | B | C | A |
| Comp. Ex. 3 | D | A | A |
| Comp. Ex. 4 | C | A | C |
| Comp. Ex. 5 | B | A | D |
| Comp. Ex. 6 | B | A | B |
| Comp. Ex. 7 | B | A | B |

When Examples 1 to 10 are compared with Comparative Example 1, it is understood that when the application of the ink is divided according to the recording method of the present invention, good results are achieved in all the image density, fixability and small letter printing. Likewise, Example 11 shows good results in all the all the image density, fixability and small letter printing compared with Comparative Example 5. Accordingly, it is understood that the recording method according to the present invention exhibits the above-described effect irrespective of the kind of the self-dispersion pigment used. When Examples 1, 4 and 10 are compared with Comparative Example 2, it is understood that since the inks of the present invention are inks high in permeability, each having a surface tension of 34 mN/m or less, the fixability thereof is good. When Examples 1, 4 and 10 are compared with Comparative Example 3, it is understood that since the organic carboxylic acid salt is added in the present invention, both image density and small letter printing are good. When Examples 1, 4 and 10 are compared with Comparative Example 4, it is understood that since the solvent having a hydrophilicity-hydrophobicity coefficient of 0.26 or more is used in the present invention, both image density and small letter printing are good.

When Examples 15 and 16 are compared with Comparative Examples 6 and 7, it is understood that since the small letter printing is good, the application of the ink is divided to control the amount of the ink applied at each application upon formation of the image to 0.7 μl/cm² or less, whereby the effect of the present invention is exhibited.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-012084, filed on Jan. 22, 2009, which is hereby incorporated by reference herein in its entirety.

1. An ink jet image forming method for forming an image by applying an ink of a color to plain paper with an ink jet recording system,
wherein the ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the following equation (A), and has a surface tension of 34 mN/m or less, and
wherein when the total amount of inks applied to a fundamental matrix for forming the image is 5.0 μl/cm² or less, and the duty of the ink applied to the fundamental matrix is 80% duty or more, the application of the ink to the fundamental matrix is conducted within a range of 1 msec or more and 200 msec or less and at plural timings within the range, and the amount of the ink applied at each timing is controlled to 0.7 μl/cm² or less,
Hydrophilicity-hydrophobicity coefficient=[(Water activity of a 20% aqueous solution)−(Molar fraction of water in the 20% aqueous solution)]/[1−(Molar fraction of water in the 20% aqueous solution)]. Equation (A):

2. An ink jet image forming method for forming an image by applying inks of plural colors to plain paper with an ink jet recording system,
wherein when the total amount of the inks applied to a fundamental matrix for forming the image is 5.0 μl/cm² or less, and the duty of at least one ink of a color of the inks applied to the fundamental matrix is 80% duty or more, the application of the at least one ink to the fundamental matrix is conducted within a range of 1 msec or more and 200 msec or less and at plural timings within the range, and the amount of the at least one ink applied at each timing is controlled to 0.7 μl/cm² or less, and
wherein the at least one ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less,
Hydrophilicity-hydrophobicity coefficient=[(Water activity of a 20% aqueous solution)−(Molar fraction of water in the 20% aqueous solution)]/[1−(Molar fraction of water in the 20% aqueous solution)]. Equation (A):

3. The ink jet image forming method according to claim 1, wherein the application of the ink to the fundamental matrix conducted at plural timings is conducted with the same recording head at all timings.

4. The ink jet image forming method according to claim 2, wherein the application of the at least one ink to the fundamental matrix conducted at plural timings is conducted with the same recording head at all timings.

5. The ink jet image forming method according to claim 1, wherein the organic carboxylic acid salt is an ammonium salt of an organic carboxylic acid.

6. The ink jet image forming method according to claim 2, wherein the organic carboxylic acid salt is an ammonium salt of an organic carboxylic acid.

7. The ink jet image forming method according to claim 1, wherein the self-dispersion pigment has an average particle size of 60 nm or more and 145 nm or less.

8. The ink jet image forming method according to claim 2, wherein the self-dispersion pigment has an average particle size of 60 nm or more and 145 nm or less.

9. The ink jet image forming method according to claim 1, wherein the application of the ink is conducted by action of thermal energy.

10. The ink jet image forming method according to claim 2, wherein the application of the ink is conducted by action of thermal energy.

11. An ink jet recording apparatus equipped with a recording head for forming an image by applying an ink of a color to plain paper with an ink jet recording system,
wherein the ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less, and
wherein the apparatus comprises a control mechanism for controlling the application of the ink such that when the total amount of the ink applied to a fundamental matrix for forming the image is 5.0 μl/cm² or less, and the duty of the ink applied to the fundamental matrix is 80% duty or more, the application of the ink to the fundamental matrix is conducted within a range of 1 msec or more and 200 msec or less and at plural timings within the above range, and the amount of the ink applied at each timing is controlled to 0.7 μl/cm² or less,
Hydrophilicity-hydrophobicity coefficient=[(Water activity of a 20% aqueous solution)−(Molar fraction of water in the 20% aqueous solution)]/[1−(Molar fraction of water in the 20% aqueous solution)]. Equation (A):

12. An ink jet recording apparatus equipped with a recording head for forming an image by applying inks of plural colors to plain paper with an ink jet recording system, wherein
wherein the apparatus comprises a control mechanism for controlling the application of the inks such that when the total amount of the inks applied to a fundamental matrix for forming the image is 5.0 μl/cm² or less, and the duty of at least one ink of a color of the inks applied to the fundamental matrix is 80% duty or more, the application of the at least one ink to the fundamental matrix is conducted within a range of 1 msec or more and 200 msec or less and at plural timings within the range, and the amount of the at least one ink applied at each timing is controlled to 0.7 μl/cm² or less, and
wherein the at least one ink is applied in a fixed amount of 0.5 pl or more and 6.0 pl or less, comprises a self-dispersion pigment, an organic carboxylic acid salt, water and a water-soluble compound having a hydrophilicity-hydrophobicity coefficient of 0.26 or more as defined by the equation (A), and has a surface tension of 34 mN/m or less,
Hydrophilicity-hydrophobicity coefficient=[(Water activity of a 20% aqueous solution)−(Molar fraction of water in the 20% aqueous solution)]/[1−(Molar fraction of water in the 20% aqueous solution)]. Equation (A):

13. The ink jet recording apparatus according to claim 11, wherein the recording head has a plurality of nozzle rows, and the ink is applied from the plurality of nozzle rows.

14. The ink jet recording apparatus according to claim 12, wherein the recording head has a plurality of nozzle rows, and the at least one ink is applied from the plurality of nozzle rows.
